(19) United States
(12) Patent Application Publication
(10) Pub. No.: US 2021/0109646 A1
(43) Pub. Date: Apr. 15, 2021

(54) METHOD AND ELECTRONIC DEVICE FOR CREATING TOGGLED APPLICATION ICON

(71) Applicant: Samsung Electronics Co., Ltd., Suwon-si (KR)

(72) Inventors: Hemant CHHABRA, Noida (IN); Anannya GOGOI, Noida (IN); Harshit OBEROI, Noida (IN); Sabyasachi KUNDU, Noida (IN); Amitoj SINGH, Noida (IN); Darpan Bharatbhai DEKIVADIYA, Noida (IN)

(21) Appl. No.: 17/065,856

(22) Filed: Oct. 8, 2020

(30) Foreign Application Priority Data
Oct. 15, 2019 (IN) 201941041796

(51) Int. Cl. G06F 3/0481; G06F 3/0484; G06F 3/0488; G06N 20/00

(52) U.S. Cl. CPC G06F 3/04817; G06N 20/00; G06F 3/0488; G06F 3/04842

(57) ABSTRACT

A method for creating a toggled application icon and an electronic device therefor are provided. The method includes identifying a plurality of applications running on an electronic device, being actively toggled on a user interface of the electronic device based on a context, detecting at least one task performed by a user, detecting at least one application among the plurality of applications as at least one foreground application, detecting at least one application among the plurality of applications as at least one background application, and generating a toggled application icon. At least one of the at least one foreground application or the at least one background application is accessible through the toggled application icon based on the at least one task.

### CROSS-REFERENCE TO RELATED APPLICATION(S)

This application is based on and claims priority under 35 U.S.C. § 119 of an Indian patent application number 201941041796, filed on Oct. 15, 2019, in the Indian Intellectual Property Office, the disclosure of which is incorporated by reference herein in its entirety.

### BACKGROUND

### 1. Filed

The disclosure relates to an electronic device. More particularly, the disclosure relates to a method for creating a toggled application icon (i.e., interactive application icon, or the like) in the electronic device.

### 2. Description of Related Art

In general, various method can be used to monitor user activity for at least two applications in an electronic device while accessing/switching for a context between the at least two applications, but the method does not create any intelligent application pair for the at least two applications as badge with interactive functionality and does not suggest a user to multitask on the badge. This results in reducing the user experience.

Thus, it is desired to address the above mentioned disadvantages or other shortcomings or at least provide a useful alternative.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method for creating a toggled application icon in an electronic device.

Another aspect of the disclosure is to a plurality of applications running on the electronic device being actively toggled on a user interface of the electronic device based on a context.

Another aspect of the disclosure is to detect at least one task performed by a user.

Another aspect of the disclosure is to detect at least one application of the plurality of applications as at least one foreground application. The at least one foreground application is accessible through a first application icon based on the at least one task.

Another aspect of the disclosure is to detect at least one application of the plurality of applications as at least one background application. The at least one background application is accessible through a second application icon based on the at least one task.

Another aspect of the disclosure is to generate the toggled application icon, where at least one of the at least one foreground application and the at least one background application are accessible through the toggled application icon based on the at least one task.

Another aspect of the disclosure is to display the toggled application icon on the user interface.

Another aspect of the disclosure is to launch the at least one foreground application and the at least one background application simultaneously on the user interface with a gesture on the toggled application icon.

Another aspect of the disclosure is to launch at least one of the at least one foreground application and the at least one background application with a gesture on the toggled application icon.

Additional aspects will be set forth in part in the description which follows and, in part, will be apparent from the description, or may be learned by practice of the presented embodiments.

In accordance with an aspect of the disclosure, a method for creating a toggled application icon is provided. The method includes identifying, by an electronic device, a plurality of applications running on the electronic device, being actively toggled on a user interface of the electronic device based on a context. Further, the method includes detecting, by the electronic device, at least one task performed by a user. Further, the method includes detecting, by the electronic device, at least one application of the plurality of applications as at least one foreground application. The at least one foreground application is accessible through a first application icon based on the at least one task. Further, the method includes detecting, by the electronic device, at least one application among the plurality of applications as at least one background application. The at least one background application is accessible through a second application icon based on the at least one task. Further, the method includes generating, by the electronic device, a toggled application icon. At least one of the at least one foreground application or the at least one background application is accessible through the toggled application icon based on the at least one task.

In an embodiment, the method may further include displaying the toggled application icon on the user interface, and launching the at least one foreground application and the at least one background application simultaneously on the user interface with a gesture on the toggled application icon.

In an embodiment, a user interface of the at least one foreground application overlaps at least a portion of a user interface of the at least one background application.

In an embodiment, a user interface of the at least one foreground application does not overlap at least a portion of a user interface of the at least one background application.

In an embodiment, the method may further include displaying the toggled application icon on the user interface, and launching at least one of the at least one foreground application and the at least one background application with a gesture on the toggled application icon.

In an embodiment, the method may further include displaying the toggled application icon on the user interface, and launching the at least one foreground application on another electronic device communicably coupled to the electronic device and the at least one background application on the electronic device.

In an embodiment, the method may further include displaying the toggled application icon on another electronic device communicably coupled to the electronic device, and launching at least one of the at least one foreground application or the at least one background application with a gesture on the toggled application icon.

In an embodiment, the context includes at least one of an intent of a user, a time, a type of applications being toggled, a frequency of toggling or a location.

In an embodiment, the type of the applications being toggled is determined based on at least one of a service category, a location of the electronic device, or an intent of the at least one task.

In an embodiment, the frequency of toggling is determined based on a number of switching between the plurality of applications, total time spent on the plurality of applications and frequency weightage.

In an embodiment, the time is determined based on an active screen time of at least one application among the plurality of applications.

In accordance with another aspect of the disclosure, an electronic device for creating a toggled application icon is provided. The electronic device includes a memory storing a plurality of applications, at least one processor, and a toggle switcher is communicably coupled to the memory and the at least one processor. The at least one processor is configured to control the toggle switcher to identify the plurality of applications running on the electronic device, being actively toggled on a user interface of the electronic device based on a context, detect at least one task performed by a user and detect at least one application of the plurality of applications as at least one foreground application, the at least one foreground application being accessible through a first application icon based on the at least one task, detect at least one application among the plurality of applications as at least one background application, the at least one background application being accessible through a second application icon based on the at least one task, and generate a toggled application icon. At least one of the at least one foreground application or the at least one background application is accessible through the toggled application icon based on the at least one task.

In accordance with another aspect of the disclosure, a method for creating a toggled application icon is provided. The method includes switching, by an electronic device, between a first application from among a plurality of applications and a second application from among the plurality of applications. Further, the method includes determining, by the electronic device, user intent associated with the first application and the second application. Further, the method includes generating, by the electronic device, the toggled application icon based on the user intent. The toggled application icon includes the first application and the second application based on the user intent.

In an embodiment, the method further includes recommending, by the electronic device, another toggled application icon based on the user intent. The other toggled application icon comprises at least one of a combination of the first application and a third application similar to the second application or a combination of a fourth application similar to the first application and the second application.

In an embodiment, the method further includes displaying at least one of the toggled application icon or another toggled application icon on the user interface. Further, the method includes performing at least one of launching the first application and the second application simultaneously on the user interface with a gesture on the toggled application icon, launching the first application and the third application simultaneously on the user interface with the gesture on another toggled application icon, or launching the fourth application and the second application simultaneously on the user interface with the gesture on another toggled application icon.

In an embodiment, the method further includes displaying at least one of the toggled application icon or another toggled application icon on the user interface. Further, the method includes performing one of launching the first application and the second application on the user interface with a gesture on the toggled application icon, launching the first application and the third application on the user interface with the gesture on another toggled application icon, and launching the fourth application and the second application on the user interface with the gesture on another toggled application icon.

In an embodiment, the method further includes displaying at least one of the toggled application icon or another toggled application icon on the user interface. Further, the method includes performing one of launching the first application on another electronic device communicably coupled to the electronic device and the second application on the electronic device, launching the first application on another electronic device communicably coupled to the electronic device and the third application on the electronic device, and launching the fourth application on another electronic device communicably coupled to the electronic device and the second application on the electronic device.

In an embodiment, the method further includes displaying the toggled application icon and another toggled application icon on another electronic device communicably coupled to the electronic device. Further, the method includes performing at least one of launching the first application and the second application on the user interface with a gesture on the toggled application icon, launching the first application and the third application on the user interface with the gesture on another toggled application icon, or launching the fourth application and the second application on the user interface with the gesture on another toggled application icon.

In an embodiment, the toggled application icon is generated based on at least one foreground feature associated with the user intent and a background feature associated with the user intent.

In accordance with another aspect of the disclosure, an electronic device for creating a toggled application icon is provided. The electronic device includes a memory for storing a plurality of applications, at least one processor, and a toggle switcher communicably coupled to the memory and the at least one processor. The at least one processor is configured to control the toggle switcher to switch between a first application among a plurality of applications and a second application among the plurality of applications, determine user intent associated with the first application and the second application, and generate the toggled application icon based on the user intent. The toggled application icon includes the first application and the second application based on the user intent.

Other aspects, advantages and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIGS. 1A and 1B are example scenarios in which an electronic device creates and utilizes a toggled application icon, according to various embodiments of the disclosure;

FIG. 2 illustrates various hardware components of the electronic device, according to an embodiment of the disclosure;

FIG. 3 illustrates various hardware components of a toggle switcher included in the the electronic device, according to an embodiment of the disclosure;

FIGS. 4A and 4B are flow charts illustrating a method for creating the toggled application icon, according to various embodiments of the disclosure;

FIG. 5 is an example flow chart illustrating various operation for creating and utilizing the toggled application icon, according to an embodiment of the disclosure;

FIG. 6 is an example scenario in which the toggled application icon utilization is depicted, according to an embodiment of the disclosure;

FIG. 7 is an example scenario in which the electronic device launches a foreground application on another electronic device communicably coupled to the electronic device and a background application launched on the electronic device, according to an embodiment of the disclosure;

FIG. 8 is an example scenario in which the electronic device launches a foreground application on another electronic device, according to an embodiment of the disclosure;

FIG. 9 is an example scenario in which a user interface of the foreground application does not overlap a portion of a user interface of the background application, according to an embodiment of the disclosure;

FIGS. 10A, 10B, 10C, and 10D are example scenarios in which various operations on the toggled application icon is depicted, according to various embodiments of the disclosure;

FIGS. 11A, 11B, 11C, and 12 are example scenarios in which switching between the application to another application using the toggled application icon is depicted, according to various embodiments of the disclosure;

FIG. 13 is an example scenario in which the toggled application icon utilization is depicted using a weight factor, according to an embodiment of the disclosure;

FIG. 14 is an example graph in which priority of tasks are depicted, according to an embodiment of the disclosure;

FIG. 15 is an example graph in which recency of the tasks are depicted, according to an embodiment of the disclosure;

FIG. 16 is an example graph in which attribute Frequency related to application are depicted, according to an embodiment of the disclosure; and

FIG. 17 is an example graph in which frequent switches between the applications are depicted, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As is traditional in the field, embodiments may be described and illustrated in terms of blocks which carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Accordingly, embodiments herein achieve a method for creating a toggled application icon. The method includes identifying, by an electronic device, a plurality of applications running on the electronic device, being actively toggled on a user interface of the electronic device based on a context. Further, the method includes detecting, by the electronic device, at least one task performed by a user. Further, the method includes detecting, by the electronic device, at least one application of the plurality of applications as at least one foreground application. The at least one foreground application is accessible through a first application icon based on the at least one task. Further, the method includes detecting, by the electronic device, at least one application of the plurality of applications as at least one background application. The at least one background application is accessible through a second application icon based on the at least one task. Further, the method includes generating, by the electronic device, a toggled application icon. The at least one of the at least one foreground application and the at least one background application are accessible through the toggled application icon based on the at least one task.

In an embodiment, the context can be determined within the application. In an example, the user is switching between Instagram® feed and Instagram® chat, so that electronic device clearly know the intent of the user.

Unlike methods and system of the related art, the proposed method can be used to monitor user activity for at least two applications in the electronic device while accessing/switching for the context and create intelligent application pair as badge (i.e., toggled application icon) with interactive functionality, and suggest the user to multitask on the badge. The intelligent application pair is generated depending on intents identified in the electronic device and can suggest two or more application as suggestion to open in a user interface to help improve user productivity. In the proposed methods, the toggled application icon is designed for two or more than two applications to work simultaneously in the electronic device, depending on screen size and other parameters. For the sake of clarity, the patent application is described with two applications, but it could be also applicable for more than two applications. The proposed method can be used to watch one or more contents and create one or more contents simultaneously in the electronic device. This results in improving the user experience in a cost and time effective mariner

The method can be used to assist the user in automated task/intent identification, understand the context of the user in the electronic device and suggest the best way to be most productive in the electronic device. This results in enhancing the user experience in the cost and time effective mariner.

The proposed method can be used to assist a user to discover (first) ability to multi task on an operating system (e.g., Android operating system, Windows operating system, iPad OS, MaC OS or the like). The proposed method can be used to intelligently recommend the user to multi task by suggesting application combos (e.g., toggled application icon, or the like) which will open corresponding application in a full screen and a pop-up view and other subsequent intelligent interfaces depending on the amount of tasks at hand This results in multi-tasking for a smaller screen smarter and highly productive. The proposed method can be used to generate the toggled application icon (e.g., interactive application icon or the like) irrespective of the screen size of the electronic device.

The proposed method can be used to generate the toggled application icon (e.g., interactive application icon or the like) based on the user behaviour learned from various applications working in the electronic device. The toggled application icon appears on the electronic device when the user needs to assess the interested applications based on the user feedback and the electronic device learns the user behaviour.

In an example, consider the user of the electronic device mother's birthday today. The user wants to give surprise to his/her mom by preparing cake for her. The user watches cake's recipe on a video-sharing website application (e.g., Youtube® or the like), simultaneously he/she writes down the ingredients list in a notepad application by frequently switching between the video-sharing website application and the notepad application. After switching multiple times between the video-sharing website application and the notepad application, the electronic device generates the toggled application icon and shows the toggled application icon to the user. If the user access the toggled application icon, the toggled application icon displays a multi-window view to access the video-sharing website application and the notepad application easily for him/her to do the both tasks together efficiently. Once the video watching and note taking activity is over, the user prepares the cake and posts on the social networking website wishing his/her mother for birthday. In an example, the multi-window view is provided because it was a small screen, but if the screen size is large then, the interface intelligence logic will create interfaces which are comfortable and usable for the user to access the multiple number of apps /tasks by the user.

In another example, based on the proposed methods, the electronic device generates the toggled application icon and shows the toggled application icon to the user. If the user access the toggled application icon, the toggled application icon displays the multi-window view to access the video-sharing website application along with user preference setting (i.e., which page user watching currently and what are the setting done in the video-sharing website application by the user) and the notepad application easily for user to do the both tasks together efficiently. This results in increasing the user experience.

In an embodiment, the electronic device is configured to switch between a first application from the plurality of applications and the second application from the plurality of applications. The electronic device is configured to determine user intent associated with the first application and the second application. Further, the electronic device is configured to generate the toggled application icon based on the user intent. The toggled application icon includes the first application and the second application based on the user intent.

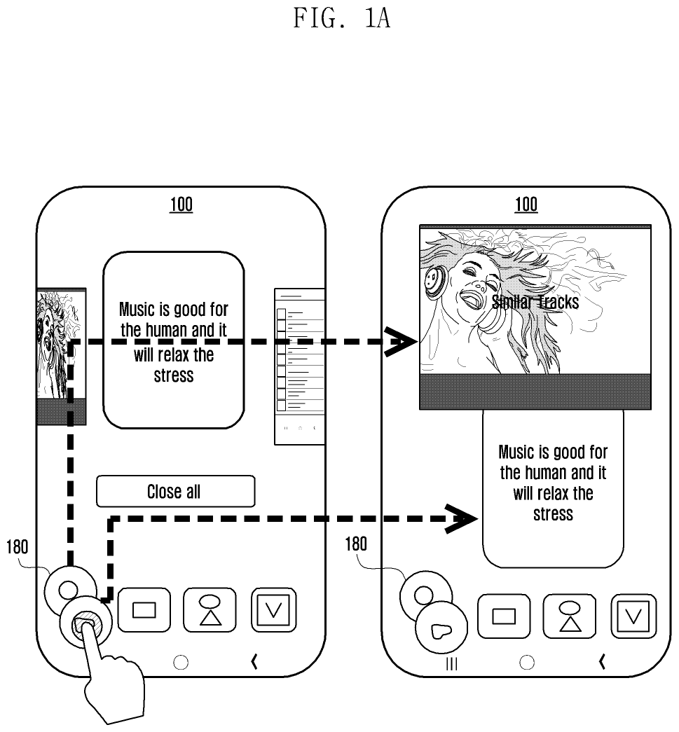

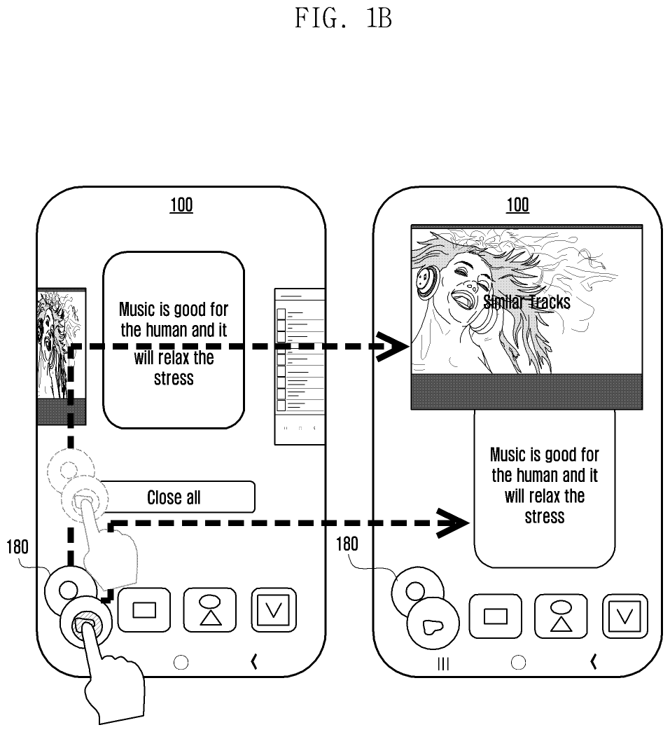

Referring now to the drawings, and more particularly to FIGS. 1A through 17, there are shown preferred embodiments.

FIGS. 1A and 1B are example scenarios in which an electronic device (100) creates and utilizes a toggled application icon or an interactive application icon (180), according to various embodiments of the disclosure. The electronic device (100) can be, for example, but not limited to a smart phone, a Personal Digital Assistant (PDA), a tablet computer, a laptop computer, an Internet of Things (IoT), a virtual reality device, a smart watch, a smart band, a flexible display device, a foldable phone, an edge based phone or the like.

Referring to FIG. 1A, in an embodiment, the electronic device (100) is configured to identify a plurality of applications being actively toggled on a user interface of a display based on a context. In an embodiment, the context includes at least one of time, a recency of a task, a point of the launch of the application, type of applications being toggled, frequency of toggling and location. The plurality of applications can be, for example, but not limited to, a social networking application, a finance application, a content sharing application, a video application, a music application, a health related application, a food related application, a learning application or the like.

In an embodiment, the type of applications being toggled is determined based on a service category, a location of the electronic device (100) and an intent of the at least one task. The at least one task can be a primary task, a secondary task, or the like.

In an embodiment, the frequency of toggling is determined based on a number of switching between the applications, total time spent on the applications and frequency weightage.

In an embodiment, the time is determined based on an active screen time of the at least one application. In another embodiment, the time corresponds to time of launch of the application or a user tap being recorded with respect to current time. In an embodiment, the time corresponds the time spent in the standalone application, expenditure of time, time duration while switching from one application to another application via a number of intermediate applications. In an embodiment, the time corresponds lapse time. In an embodiment, the time corresponds time of the day/month/year. In an example, location of the smart phone at a place is with respect to time of the day, time of the application launched and any event from the calendar application with respect to the year/month.

In an embodiment, the point of the launch of the application corresponds to a home screen, a recent panel, notification panel, inside the application or the like.

In an embodiment, the time is determined based on the user of the electronic device (100) uses multiple applications to complete the task. In another embodiment, the time is determined based on the user of the electronic device (100) uses multiple applications simultaneously to get complicated actions done. In another embodiment, the time is determined based on the user of the electronic device (100) uses certain application at certain times of the day for certain duration (example: will only book cab during week office hours, will only order for food while the times are for meals etc.). In another embodiment, the time is determined based on the screen ON time is referred as usage hours.

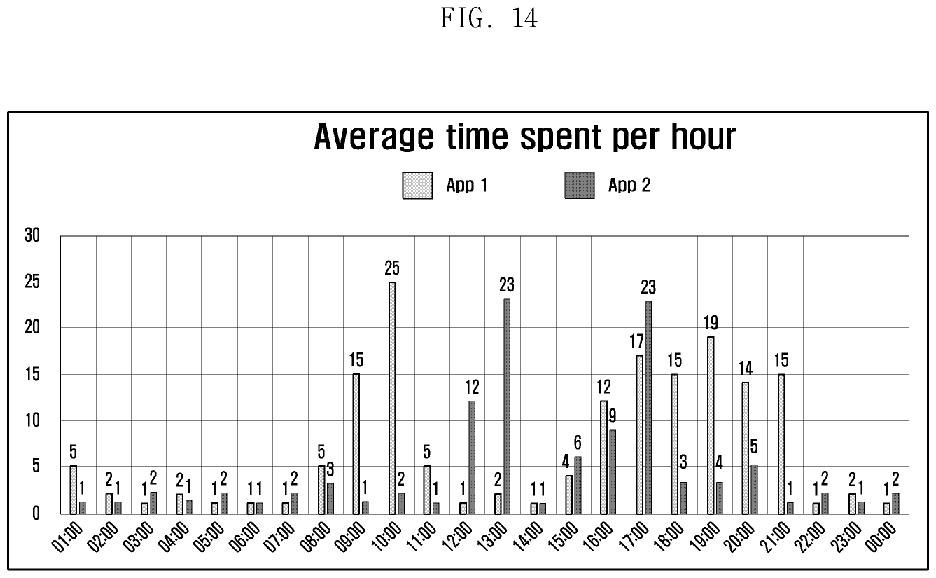

FIG. 14 is an example graph in which priority of tasks are depicted, according to an embodiment of the disclosure.

Referring to FIG. 14, priority of tasks and an average time spent per hour by the user are illustrated.

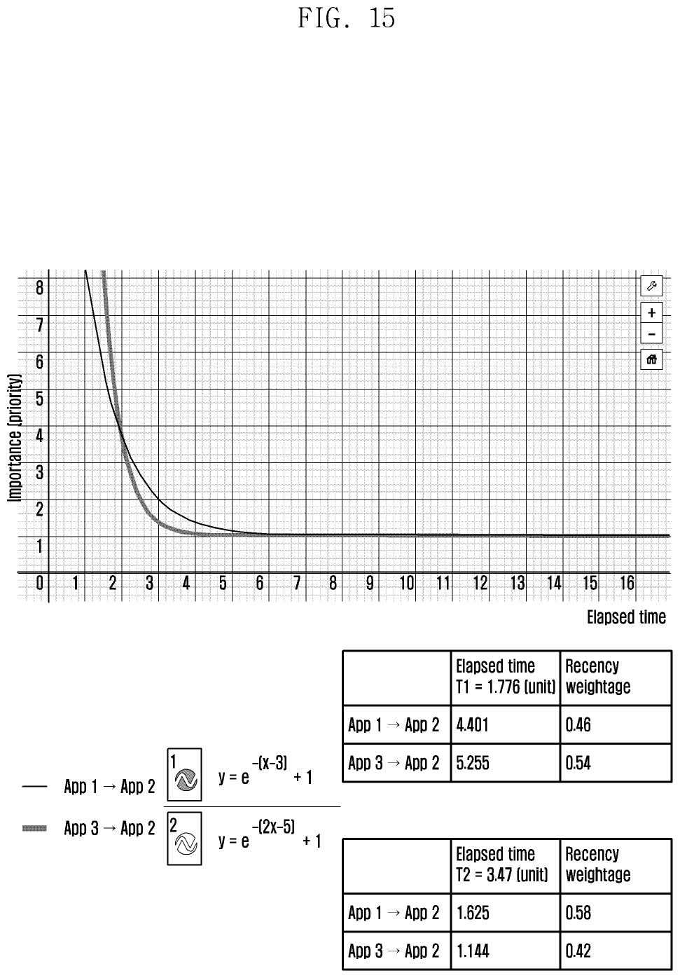

FIG. 15 is an example graph in which recency of the tasks are depicted, according to an embodiment of the disclosure.

Referring to FIG. 15, based on the most recently usage of the applications in the electronic device (100), a toggle switcher (not shown) should keep in account the recency of the tasks, as shown in the FIG. 15, being accomplished as shown in the Equation 1.

y=e^{-(αx-Y)}+β Equation 1

where α is a category (e.g., business category, entertainment category, developer tool category, education category, games category, news category, lifestyle category, reference category, travel category, weather category, productivity category, video category, utilities category, social networking category, photography category, medical category, graphic & design category, finance category), β=location of the electronic device (100). The location can be a shopping centre, outside home, outside workstation, frequently visited places, travelling path, public transport or the like, γ Intent of the task at hand, deducing the intent of the user from an intelligent input.

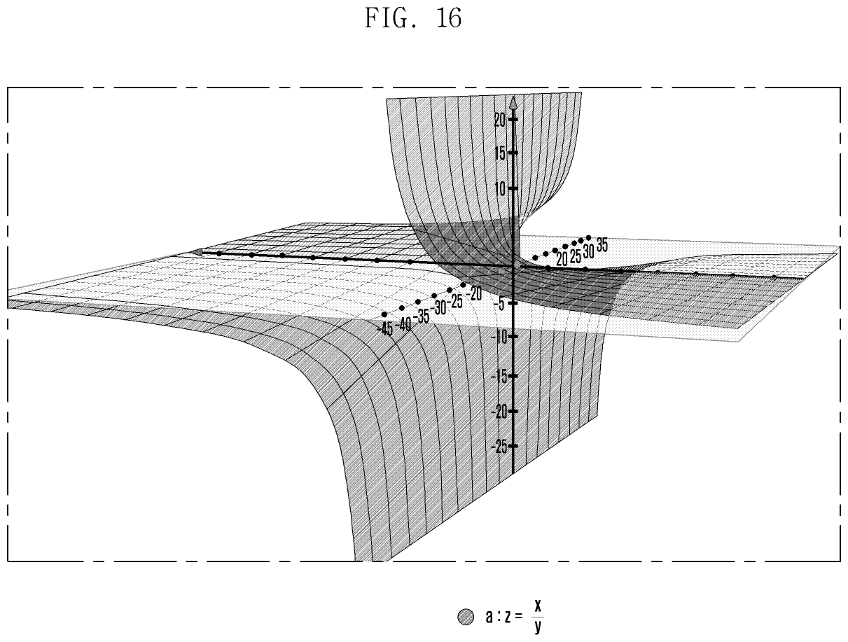

FIG. 16 is an example graph in which attribute Frequency related to application are depicted, according to an embodiment of the disclosure.

Referring to FIG. 16, in an embodiment, attribute frequency time factor is determined based on following factors (i.e., X=Count of switches between two application, Y=Total time spent on two application, and Z=Frequency weightage (X/Y)).

Time

| | | |
|---|---|---|
| Last 5 Minutes (A) | Last 1 Hour (B) | Last Day (C) |

Weight = αA + βB + γC

where α Coefficient: Value=1, β Coefficient: Value=0.1, γ Coefficient: Value=0.05, and α>β>γ

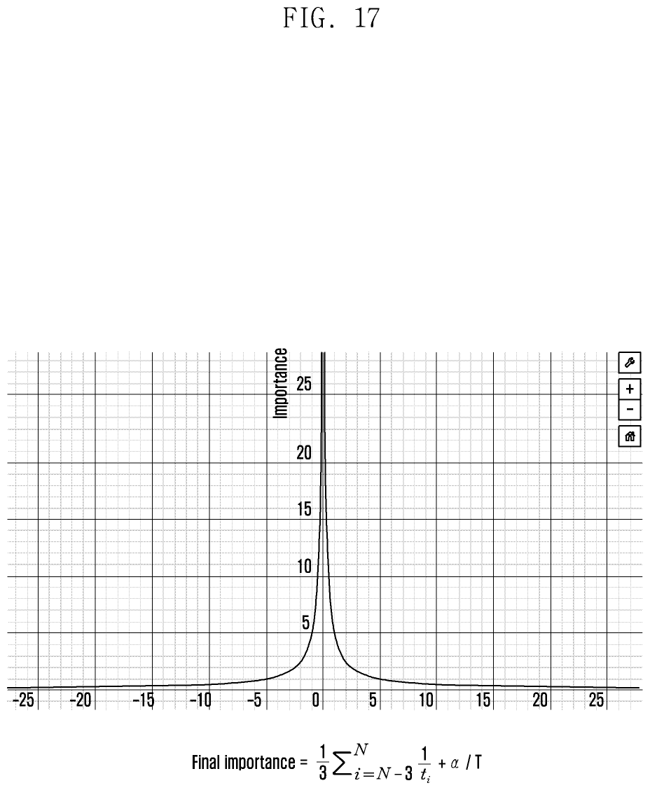

FIG. 17 is an example graph in which frequent switches between the applications are depicted, according to an embodiment of the disclosure.

Referring to FIG. 17, in an embodiment, an attribute interference time is computed based on an interference time (t) between the first application and the second application, number of switches (N) between the first application and the second application, and mean interference time (T) for N (the first application and the second application) switches are determined by below Equations 2-4.

$$\begin{matrix}{\vert A \vert}_{{Start Time}_{of app} {End Time}_{of apP}} {{↔}_{{t}_{1}}}^{{Apps}^{Time b / w}} \vert B {\vert}_{{t}_{2}} \vert A {\vert}_{ {t}_{3}} \vert B \vert {…}^{{t}_{N}} \vert A \vert & Equation 2 \\ T = \frac{1}{N} ( {t}_{1} + {t}_{2} + {t}_{3} … + {t}_{N} ) = \frac{1}{N} {\sum }_{i = 1}^{N} {t}_{i} & Equation 3 \\ \frac{1}{3} {\sum }_{i = N - 3}^{N} \frac{1}{{t}_{i}} + α / T & Equation 4\end{matrix}$$

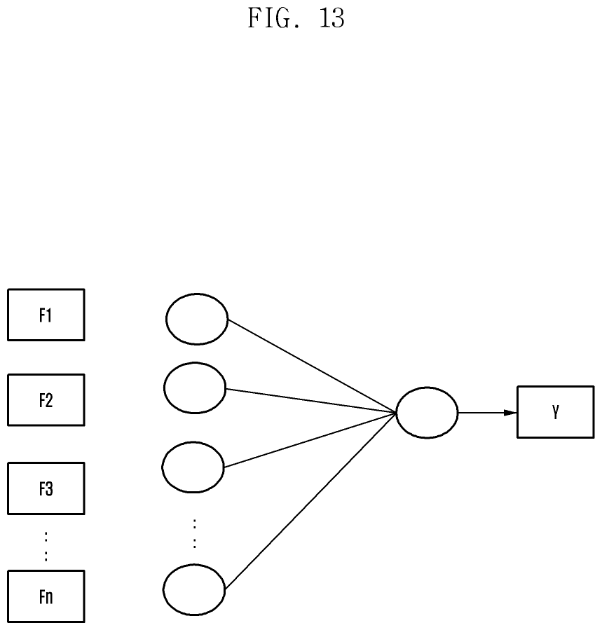

FIG. 13 is an example scenario in which the toggled application icon utilization is depicted using a weight factor, according to an embodiment of the disclosure.

Referring to FIG. 13, in order to find the importance of features through the machine learning. Consider, Y is the probability for the first application and the second application combo recommendation (i.e., toggled application icon).

Y=w₁F₁+w₂F₂+w₃F₃+ . . . +wₙFₙ Equation 5

where wᵢ is the weight associated with i^{th} feature.

The relative importance of a feature can be calculated using the below Equation 6:

ImpWᵢ=Wᵢ/Σᵢ₌₀ⁿW Equation 6

Given a large enough dataset, the weights of the architecture can be learnt using back-propagation along with stochastic gradient descent.

The cost function will be cross-entropy loss:

J=y log(y′)+(1−y)log(1−y′) Equation 7

The weight updating can be as below Equation 8:

Wᵢ=Wᵢ−α*dJ/dWᵢ Equation 8

Alpha—learning rate which would imply by how much the user want to change the current weight value, and dJ/dW—partial derivative of the loss function with respect to W (weight) values. The same concept can be extended to multiclass classification as well. Then F would be n×l dimensional vector, W would be maximum dimensional vector. m is equal to no. of classes

W^{T}*F+c would give us m×l dimensional vector, (y₁, y₂, y₃, . . . yₙ). [yᵢ is the i^{th} class output] The above outputs can be changed to a probability distribution:

Yᵢ=θ^{Yi}Σᵢ₌₀^{m}yYi Equation 9

Average weight of

$$\begin{matrix}{F}_{i} = ( 1 / m ) * ( {w}_{11} + {w}_{12} + {w}_{13} + …… + {w}_{lm} ) & Equation 10 \\ = {( 1 / m )}^{*} ( {\sum }_{j = 0}^{m} Wij ) & Equation 11\end{matrix}$$

Importance of

Fᵢ=Fᵢ/Σᵢ₌₀ⁿFi Equation (12)

On device user feedback learning: The proposed method can be used to always learn from any and every intervention from the user (i.e., the user is doing anything on the screen) in a background. The proposed method does not require any manual intervention from the user when the method wants to learning a trait about the user. If the suggestions are used or not used then, the method can be used to learn from any and every intervention from the user. The method can be used learn accidental opening, an intentional closing, and unintentional closing.

In an example, the user feedback is taken which has two options (i.e., “useful” and “not useful”).

The “useful”: when the interactive application icon (180) is suggested to the user and the user voluntarily selects the interactive application icon (180) and spends time greater than a predefined time then, this option may be considered as replacement for the useful option.

The “not useful”: when “not useful is selected” then 3 new options are shown.

Wrong: when the user removes the interactive application icon (180) only or spends less time than a predefined time on the interactive application icon (180) or pressed cross button on the interactive application icon (180) then it could be thought of as choosing the wrong option.

Too fast: Suppose, the method can be used to suggest the interactive application icon (180) to the user and after some time of the usage in the same direction as a combo, the user selects the suggestion then it can be thought that the combo can be suggested way before the ideal time it should have been. This scenario can be thought of as too fast options.

Too slow: Suppose, the user switching between the two applications, but our suggestion does not change for some time, if the user continues to switch between the two applications and as soon as the combo is suggested, the user choose it and spends consider amount of time. This scenario can be thought of as too slow options.

All the options are identified by the electronic device (100) and learned by the electronic device (100) in the background using the machine learning procedure e.g., neural network procedure, deep learning procedure, convolution based neural network procedure, linear regression procedure, logistic regression procedure, an adaptive logic regression procedure, a support vector machine procedure, naive Bayes classifier procedure, random forest procedure, recurrent neural network, pattern recognition procedure, artificial intelligent procedure or the like.

In an embodiment, the point of the launch of the application corresponding to the home screen, the recent panel, the notification panel, inside the application are determined based on the preference of the user learned by the electronic device (100) using the machine learning procedure. Further, the electronic device (100) is configured to display the icon in the portion of the home screen, the recent panel, the notification panel, inside the application based on the preference of the user.

Further, the electronic device (100) is configured to detect at least one task performed by the user and detect at least one application of the plurality of applications as at least one foreground application. The at least one foreground application is accessible through a first application icon based on the at least one task. Further, the electronic device (100) is configured to detect at least one application of the plurality of applications as at least one background application. The at least one background application is accessible through a second application icon based on the at least one task. Further, the electronic device (100) is configured to generate the toggled application icon (180). The at least one of the at least one foreground application and the at least one background application are accessible through the toggled application icon (180) based on the at least one task.

In an example, as shown in the FIG. 1A, consider the user of the electronic device (100) listen the music and taking notes in the notepad at a time. Based on the proposed method, after switching multiple times between the music application and the notepad application, the electronic device (100) generates the toggled application icon (180) and shows to the user. If the user accesses the toggled application icon (180), the toggled application icon (180) displays a multi-window view to access the music application and the notepad application easily for him/her to do the both tasks together efficiently.

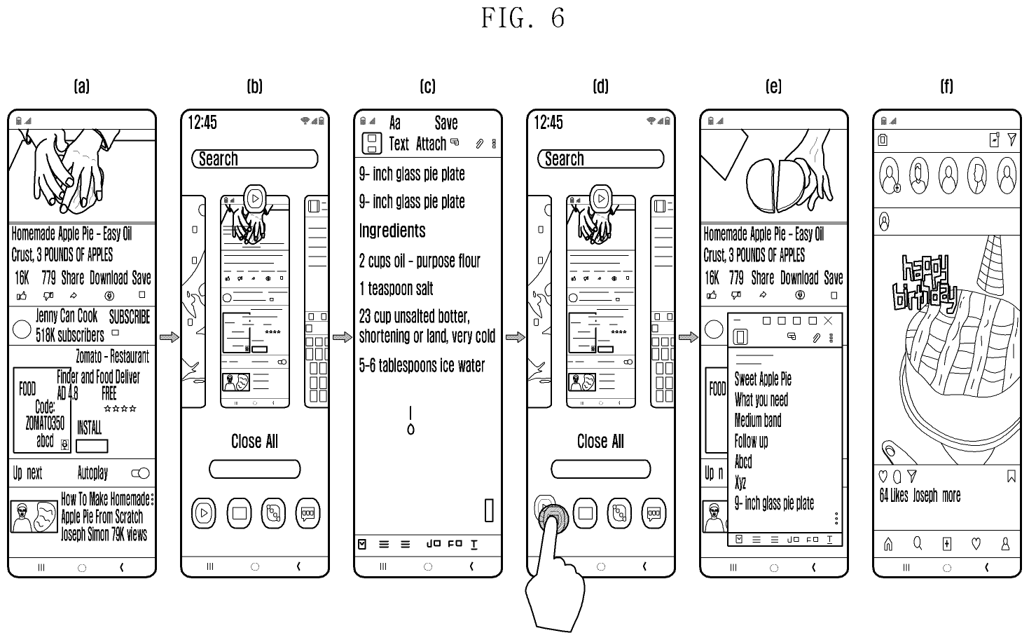

FIG. 6 is an example scenario in which the toggled application icon utilization is depicted, according to an embodiment of the disclosure.

Referring to FIG. 6, in an example, as shown in the notations or parts (a) to (f) of FIG. 6, consider the user of the electronic device mother's birthday today. The user wants to give surprise to his/her mom by preparing cake for her. The user watches cake's recipe on a video-sharing website application (e.g., Youtube or the like), simultaneously he/she writes down the ingredients list in the notepad application by frequently switching between the video-sharing website application and the notepad application. Based on the proposed method, after switching multiple times, the electronic device (100) generates the toggled application icon (180) and shows to the user. If the user accesses the toggled application icon (180), the toggled application icon (180) displays a multi-window view to access the video-sharing website application and the notepad application easily for him/her to do the both tasks together efficiently. Once the video watching and note taking activity is over, the user prepares the cake and posts on a social networking website (e.g., Facebook®, or the like) wishing his/her mother for birthday.

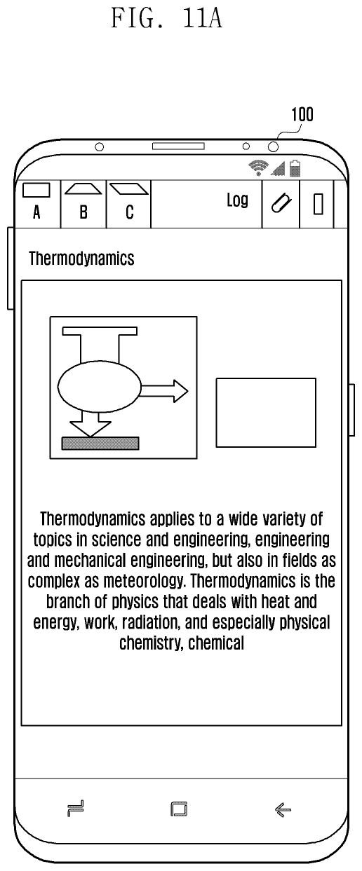

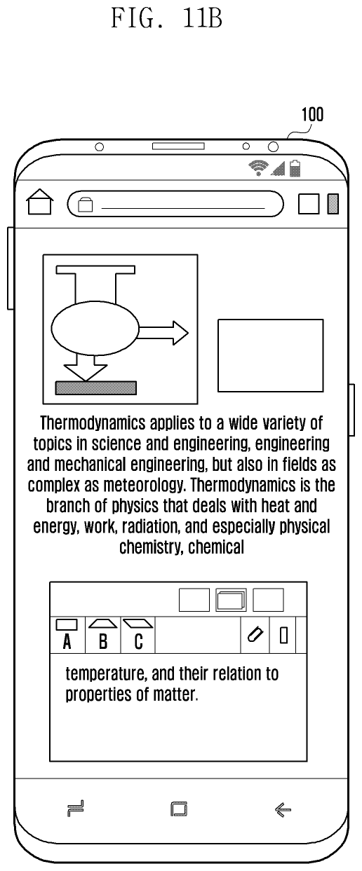

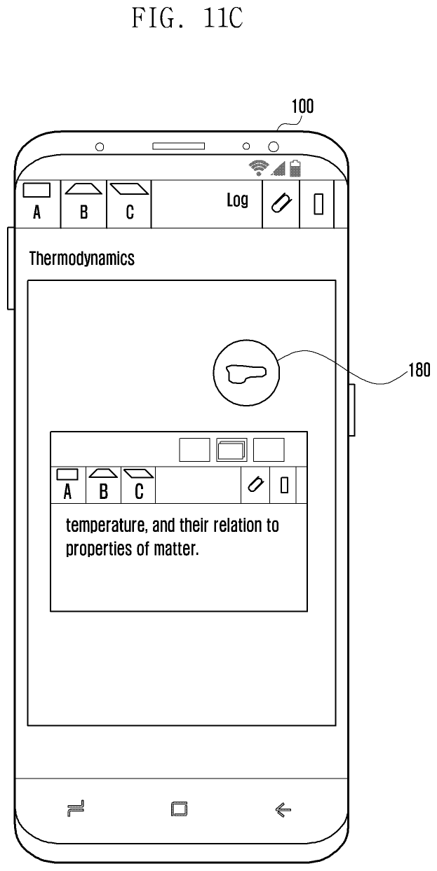

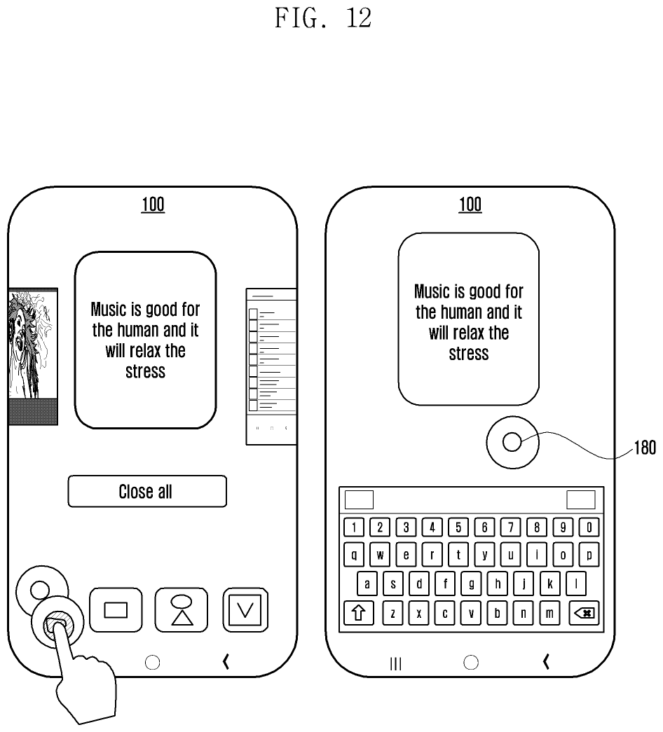

FIGS. 11A, 11B, 11C, and 12 are example scenarios in which switching between the application to another application using the toggled application icon is depicted, according to various embodiments of the disclosure.

Referring to FIGS. 11A to 11C, the user of the electronic device (100) switches from the foreground application (e.g., education application) to the background application (e.g., notepad application) using the toggled application icon (180) and vice versa. This results in increasing the user experience.

Referring to FIG. 12, the miniature preview of two frequently switched application is displayed in a recent panel occupying 1 space out of 4 suggested application. The electronic device (100) suggest the 2^{nd} combo application as a floater on 1^{st} application when the switching between the first application and the second application are detected. The pop-up floater suggestion when user behaviour is learnt over time. In another example, the point of the appearance of the of the toggled application icon appeared corresponding to the home screen, the recent panel, the notification panel, inside the application are determined based on the preference of the user learned by the electronic device using the machine learning procedure. Further, the electronic device (100) is configured to display the icon in the portion of the home screen, the recent panel, the notification panel, inside the application based on the preference of the user.

In an embodiment, the electronic device (100) displays the toggled application icon on the user interface. Further, the electronic device (100) launches the at least one foreground application and the at least one background application simultaneously on the user interface with a gesture on the toggled application icon (180). The gesture can be, for example, long press gesture, an eye gaze gesture, a hover gesture, a touch input gesture or the like.

In an embodiment, a user interface of the foreground application overlaps at least a portion of a user interface of the background application. The overlap occurs when the screen size of the electronic device (100) is smaller. In an example, the overlap occurs based on a screen size of the electronic device (100), a resolution of the content (e.g., video running in the application, or the like), and user input on the application. In an example, the user types in the notepad application and watches in the video application, the notepad application overlaps the video application. This results in enhancing the user experience. In an example, the user types in the notepad application and watches in the video application, based on the proposed methods, the electronic device assigns more spaces for the notepad application and less space for the video application based on the user input and screen resolution.

In an example, the electronic device (100) learns the user behavior as to which the application should be in foreground and which application should be in background based on several factors that can be used to decide it. In an example, an image analysis can be done on both the applications which could extract the image of interest and analyze and also if the screen contains any text can be analyzed to make decision, and also the percentage of screen covered by foreground and background can be learnt over time.

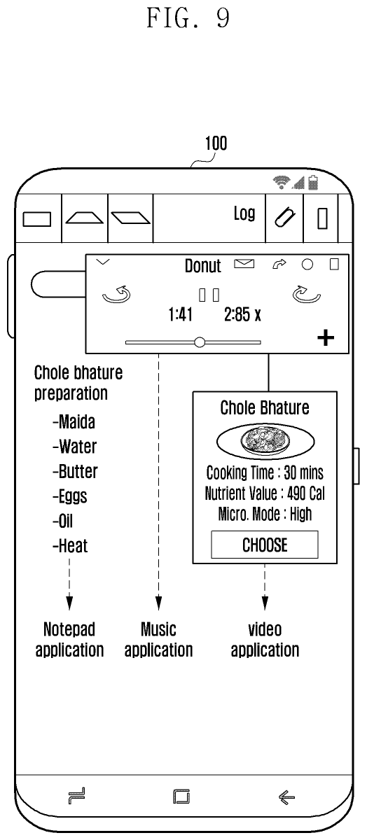

FIG. 9 is an example scenario in which a user interface of the foreground application does not overlap a portion of a user interface of the background application, according to an embodiment of the disclosure.

In an embodiment, the user interface of the foreground application does not overlap at least a portion of the user interface of the background application.

Referring to FIG. 9, the user interface of the notepad application does not overlap at least the portion of the user interface of the music application and the video application. In another example, the overlapping is determined based on the input received from the user, frequent usage of the application, and screen size.

In an embodiment, the electronic device (100) displays the toggled application icon (180) on the user interface. Further, the electronic device (100) launches at least one of the at least one foreground application and the at least one background application with the gesture on the toggled application icon (180).

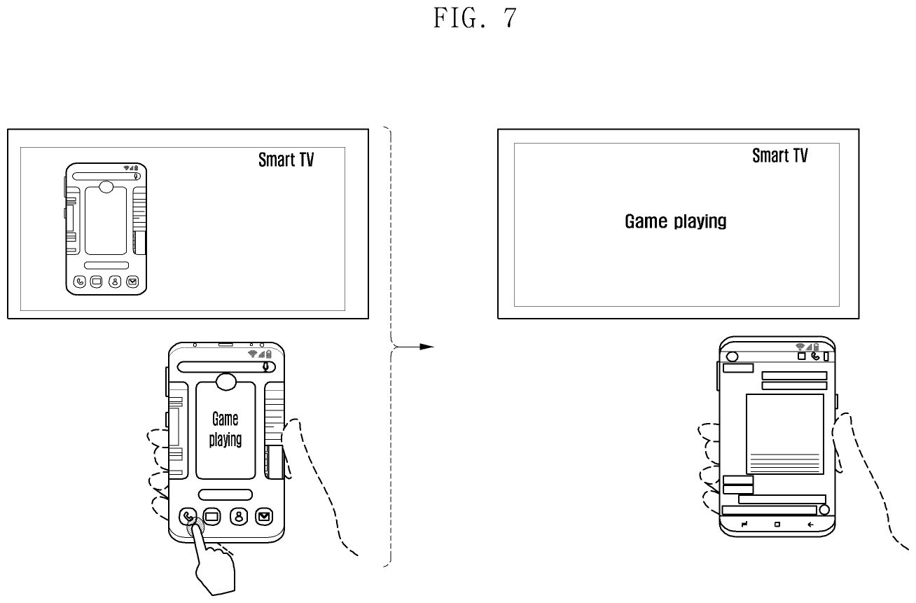

FIG. 7 is an example scenario in which the electronic device launches a foreground application on another electronic device communicably coupled to the electronic device and a background application launched on the electronic device, according to an embodiment of the disclosure.

In an embodiment, the electronic device (100) displays the toggled application icon on the user interface. Further, the electronic device (100) launches the at least one foreground application on another electronic device communicably coupled to the electronic device (100) and the at least one background application on the electronic device (100).

Referring to FIG. 7, a screen mirroring is ON when the smart phone is connected to the smart television (TV). Based on the proposed methods, when the user taps on the toggled application icon (180), the app in consumption category like game application opens on the smart TV in a full screen and another application (e.g., chat application) in combo (creation category) opens in the full screen on the smart phone automatically.

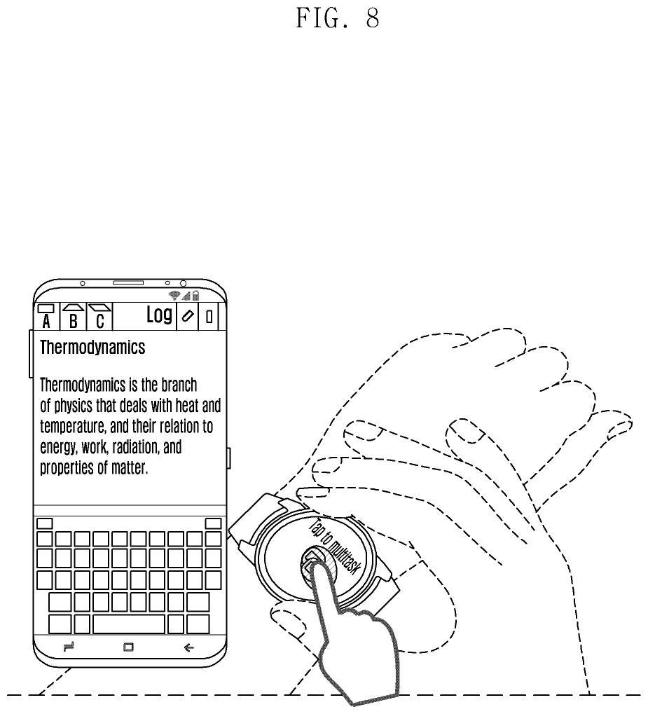

FIG. 8 is an example scenario in which the electronic device launches a foreground application on another electronic device, according to an embodiment of the disclosure.

Referring to FIG. 8, when the smart phone is connected to the smart watch, while the user is multitasking via double tapping on recent button/home button, recent panel is not displayed, hence the user misses the suggestion shown in the recent panel. Based on the proposed methods, the toggled application icon (180) can be displayed on the smart watch.

In an embodiment, the electronic device (100) displays the toggled application icon (180) on another electronic device communicably coupled to the electronic device (100). Further, the electronic device (100) launches at least one of the at least one foreground application and the at least one background application with the gesture on the toggled application icon (180).

For the sake of clarity, in the disclosure, the toggled application icon (180) is created based on two applications and two tasks (i.e., primary task and secondary task), but the toggled application icon (180) is created based on more than two applications and more than two tasks.

Referring to FIG. 1B, in an embodiment, the electronic device (100) is configured to switch between a first application from the plurality of applications and the second application from the plurality of applications. The electronic device (100) is configured to determine user intent associated with the first application and the second application. Further, the electronic device (100) is configured to generate the toggled application icon based on the user intent. The toggled application icon includes the first application and the second application based on the user intent.

Further, the electronic device (100) is configured to recommend another toggled application icon based on the user intent as shown in the FIG. 1B. The other toggled application icon comprises at least one of the combination of the first application and a third application similar to the second application and combination of a fourth application similar to the first application and the second application.

In an embodiment, further, the electronic device (100) is configured to display at least one of the toggled application icon and another toggled application icon on the user interface. Further, the electronic device (100) is configured to perform one of: launch the first application and the second application simultaneously on the user interface with the gesture on the toggled application icon, launch the first application and the third application simultaneously on the user interface with the gesture on another toggled application icon, and launch the fourth application and the second application simultaneously on the user interface with the gesture on another toggled application icon.

In an embodiment, further, the electronic device (100) is configured to display at least one of the toggled application icon and another toggled application icon on the user interface. Further, the electronic device (100) is configured to perform one of: launch the first application and the second application on the user interface with the gesture on the toggled application icon, launch the first application and the third application on the user interface with the gesture on another toggled application icon, and launch the fourth application and the second application on the user interface with the gesture on another toggled application icon.

In an embodiment, further, the electronic device (100) is configured to display at least one of the toggled application icon and another toggled application icon on the user interface. Further, the electronic device (100) is configured to perform one of: launch the first application on another electronic device communicably coupled to the electronic device and the second application on the electronic device, launch the first application on another electronic device communicably coupled to the electronic device and the third application on the electronic device, and launch the fourth application on another electronic device communicably coupled to the electronic device and the second application on the electronic device.

In an embodiment, further, the electronic device (100) is configured to display the toggled application icon and another toggled application icon on another electronic device communicably coupled to the electronic device. Further, the electronic device (100) is configured to perform one of: launch the first application and the second application on the user interface with the gesture on the toggled application icon, launch the first application and the third application on the user interface with the gesture on another toggled application icon, and launch the fourth application and the second application on the user interface with the gesture on another toggled application icon.

In an embodiment, the toggled application icon is generated based on at least one foreground feature associated with the user intent and a background feature associated with the user intent.

Although the FIGS. 1A and 1B show overview of the electronic device (100) but it is to be understood that other embodiments are not limited thereon. In other embodiments, the electronic device (100) may include less or more number of components. Further, the labels or names of the components are used only for illustrative purpose and does not limit the scope of the disclosure.

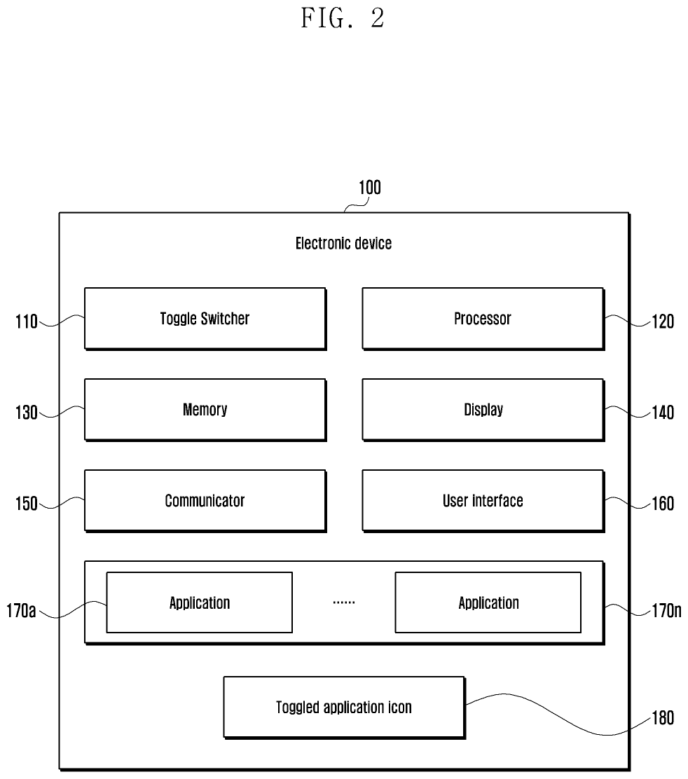

FIG. 2 illustrates various hardware components of the electronic device (100), according to an embodiment of the disclosure.

Referring to FIG. 2, in an embodiment, the electronic device (100) includes a toggle switcher (110), at least one processor or a processor (120), a memory (130), a display (140), a transceiver or a communicator (150), a user interface (160), the plurality of applications (170a-170n), and the toggled application icon (180). The processor (120) is coupled with the toggle switcher (110), the memory (130), the display (140), the communicator (150), the user interface (160), the plurality of applications (170a-170n) and the toggled application icon (180). The memory (130) includes the plurality of applications (170a-170n).

In an embodiment, the toggle switcher (110) is configured to identify the plurality of applications (170a-170n) running on the electronic device (100) being actively toggled on the user interface (160) of the display (140) based on the context. Further, the toggle switcher (110) is configured to detect the at least one task performed by the user and detect at least one application of the plurality of applications (170a-170n) as the at least one foreground application. Further, the toggle switcher (110) is configured to detect the at least one application of the plurality of applications (170a-170n) as the at least one background application. Further, the toggle switcher (110) is configured to generate the toggled application icon (180). The toggled application icon (180) is displayed on the display (140).

In an embodiment, the toggle switcher (110) is further configured to display the toggled application icon (180) on the user interface (160) and launch the at least one foreground application and the at least one background application simultaneously on the user interface (160) with the gesture on the toggled application icon (180).

In another embodiment, the toggle switcher (110) is further configured to display the toggled application icon (180) on the user interface (160) and launch at least one of the at least one foreground application and the at least one background application with the gesture on the toggled application icon (180).

In an embodiment, the toggle switcher (110) is further configured to display the toggled application icon (180) on the user interface (160) and launch the at least one foreground application on another electronic device communicably coupled to the electronic device (100) and the at least one background application on the electronic device (100).

In an embodiment, the toggle switcher (110) is further configured to display the toggled application icon (180) on another electronic device communicably coupled to the electronic device (100) and launch at least one of the at least one foreground application and the at least one background application with a gesture on the toggled application icon (180).

In an embodiment, the toggle switcher (110) is configured to switch between the first application and the second application and determine user intent associated with the first application and the second application. Further, the toggle switcher (110) is configured to generate the toggled application icon based on the user intent. The toggled application icon includes the first application and the second application based on the user intent. Further, the toggle switcher (110) is configured to recommend another toggled application icon based on the user intent. The other toggled application icon comprises at least one of the combination of the first application and a third application similar to the second application and combination of a fourth application similar to the first application and the second application.

The processor (120) is configured to execute instructions stored in the memory (130) and to perform various processes. The communicator (150) is configured for communicating internally between internal hardware components and with external devices via one or more networks.

The memory (130) also stores instructions to be executed by the processor (120). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In some examples, the memory (130) can be configured to store larger amounts of information than the memory. In certain examples, a non-transitory storage medium may store data that can, over time, change (e.g., in Random Access Memory (RAM) or cache).

Although the FIG. 2 shows various hardware components of the electronic device (100) but it is to be understood that other embodiments are not limited thereon. In other embodiments, the electronic device (100) may include less or more number of components. Further, the labels or names of the components are used only for illustrative purpose and does not limit the scope of the disclosure. One or more components can be combined together to perform same or substantially similar function to create the toggled application icon in the electronic device (100).

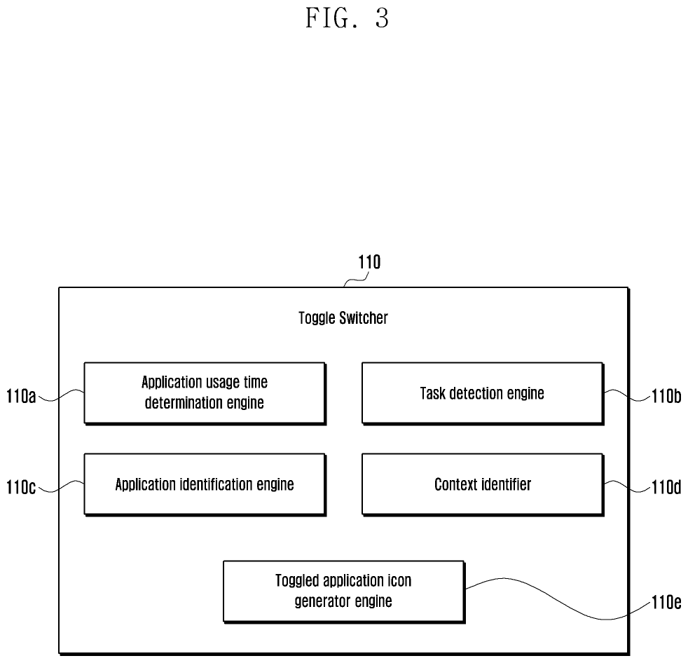

FIG. 3 illustrates various hardware components of the toggle switcher (110), according to an embodiment of the disclosure.

Referring to FIG. 3, in an embodiment, the toggle switcher (110) includes an application usage time determination engine (110a), a task detection engine (110b), an application identification engine (110c), a context identifier (110d) and a toggled application icon generator engine (110e).

The application usage time determination engine (110a) determines the usage time of the application. It means how many hours the user uses the application, the user uses the application in a day, and when the user uses the application, etc. The task detection engine (110b) determines the task performed in the application. In an example, the user may take notes in the notepad application from the learning application or the teaching video. The application identification engine (110c) determines a type of the application. In an example, the application corresponds to the social networking application, a learning application or the like. The context identifier (110d) determines the context based on the task. The toggled application icon generator engine (110e) generates the toggled application icon (180) based on the task performed by the user on the applications.

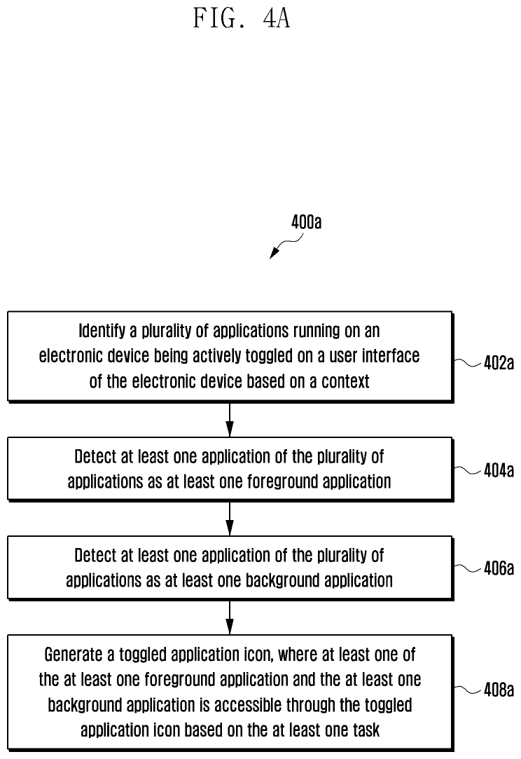

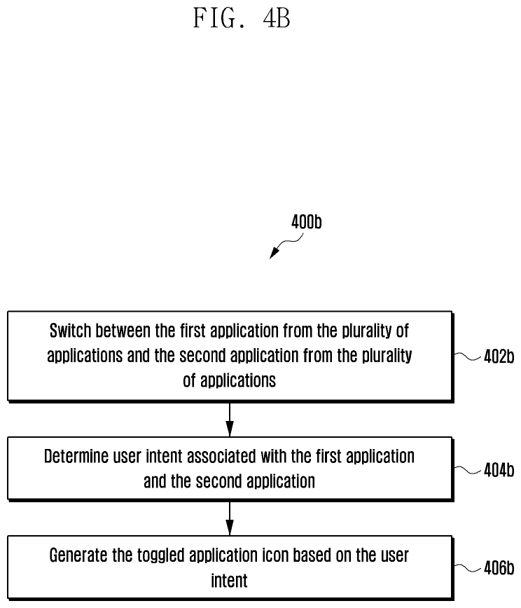

FIG. 4A and 4B are flow charts 400a and 400b illustrating a method for creating the toggled application icon (180), according to various embodiments of the disclosure.

Referring to FIG. 4A, the operations 402a-408a are performed by the toggle switcher (110). At operation 402a, the method includes identifying the plurality of applications (170a-170n) running on the electronic device (100) being actively toggled on the user interface (160) based on the context. At operation 404a, the method includes detecting the at least one application of the plurality of applications (170a-170n) as the at least one foreground application. At operation 406a, the method includes detecting at least one application of the plurality of applications (170a-170n) as the at least one background application. At operation 408a, the method includes generating the toggled application icon (180).

Referring to FIG. 4B, the operations 402b-406b are performed by the toggle switcher (110). At operation 402b, the method includes switching between the first application and the second application. At operation 404b, the method includes determining the user intent associated with the first application and the second application. At operation 406b, the method includes generating the toggled application icon based on the user intent. The toggled application icon includes the first application and the second application based on the user intent.

The various actions, acts, blocks, steps, or the like in the flow diagram (400a and 400b) may be performed in the order presented, in a different order or simultaneously. Further, in some embodiments, some of the actions, acts, blocks, steps, or the like may be omitted, added, modified, skipped, or the like without departing from the scope of the disclosure.

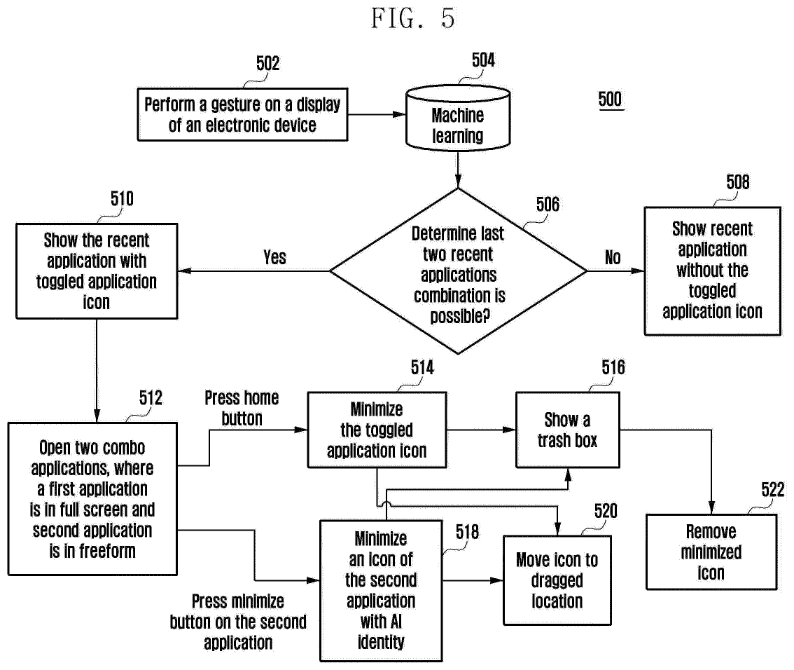

FIG. 5 is an example flow chart (500) illustrating various operations for creating the toggled application icon (180), according to an embodiment of the disclosure. The operations 502-522 are performed by the toggle switcher (110).

Referring to FIG. 5, at operation 502, the method includes performing the gesture (e.g., long press, hover or the like) on the display (140) of the electronic device (100). At operation 504, the method includes performing the machine learning on the electronic device. At operation 506, the method includes determining whether a combination of the last two recent applications is possible. If last two recent applications combination is not possible then, at operation 508, the method includes showing recent application without the toggled application icon (180). If last two recent applications combination is possible then at operation 510, the method includes showing the recent applications with the toggled application icon (180). At operation 512, the method includes opening two combo applications, where the first application is in full screen and second application is in freeform. At operation 514, the method includes minimizing the toggled application icon (180) by long press on the toggled application icon (180). At operation 516, the method includes showing the trash box. At operation 518, the method includes minimizing the icon of the second application with an artificial intelligent (AI) identity. At operation 520, the method includes moving icon to dragged location by long press on the toggled application icon (180). At operation 522, the method includes removing the minimized icon. The FIG. 5 is explained from the example point of view. For the person having the ordinary skilled in the art, the method can be used to createe and utilizee the toggled application icon (180) irrespective of the screen size of the electronic device (100).

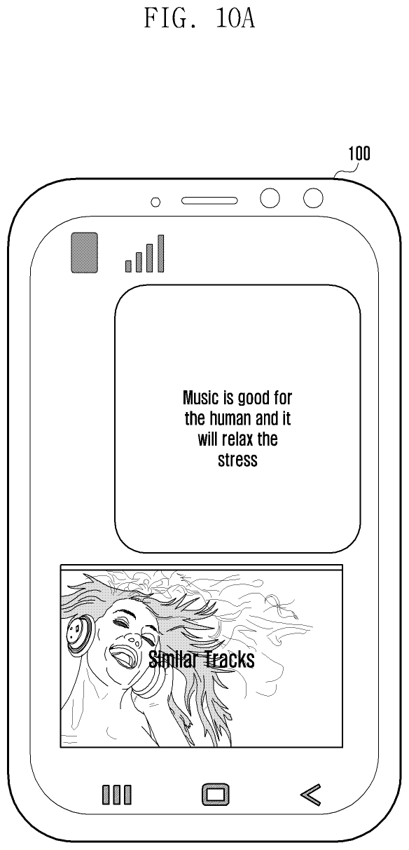

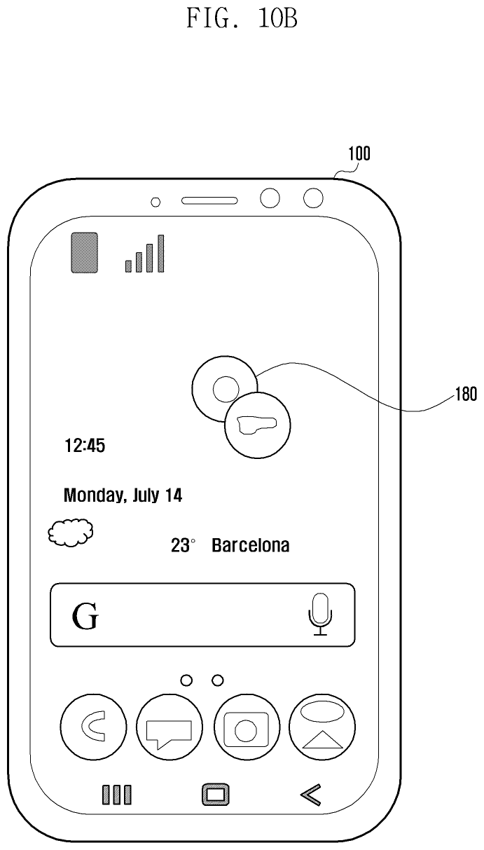

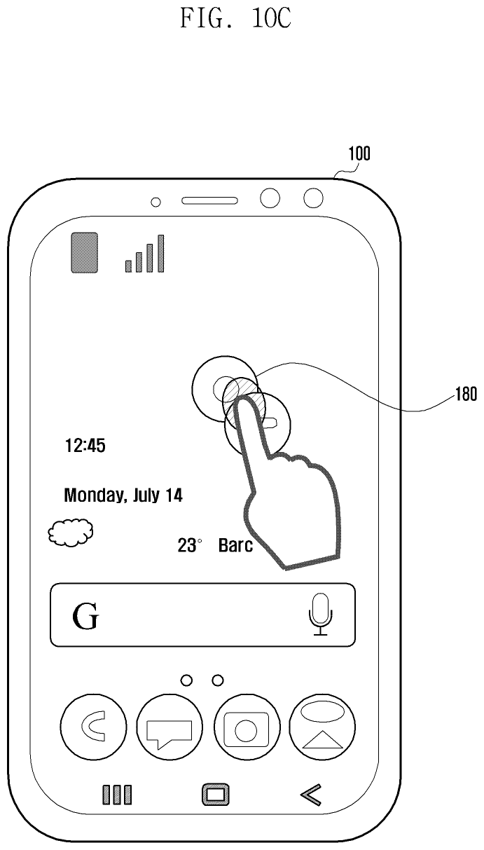

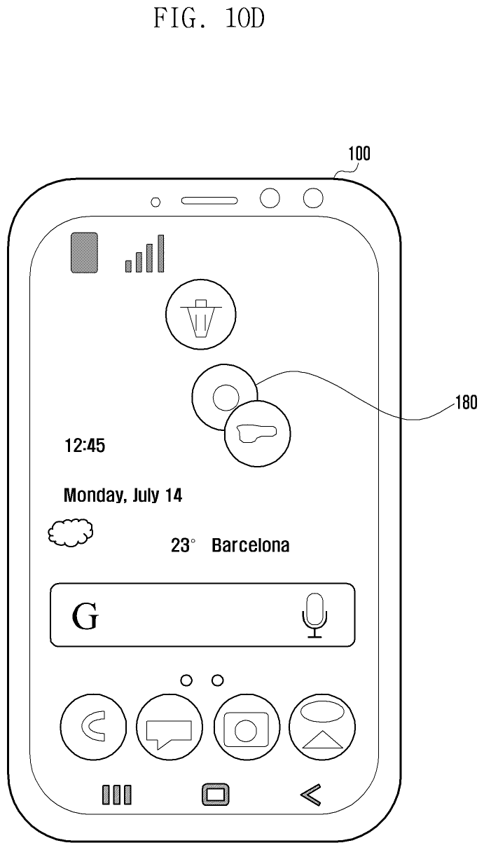

FIGS. 10A, 10B, 10C, and 10D are example scenarios in which various operations on the toggled application icon is depicted, according to various embodiments of the disclosure.

Referring to FIGS. 10A, 10B, 10C, and 10D, in an example, as shown in the FIG. 10A, the user uses the notepad application and music application. Based on the proposed method, the electronic device (100) creates the toggled application icon (180) corresponding to the notepad application and the music application as shown in the FIG. 10B. As shown in the FIG. 10C, user long presses on the toggled application icon (180), so that the trash box is appeared on the display as shown in the FIG. 10D. If the user wishes, the user can move the toggled application icon (180) to the trash box. For smaller screen, the electronic device (100) records the user input/choice from the gesture input or tap input, but for a bigger screen, the tap input or gesture is replaced by a mouse, cursor or other form of input.

The various actions, acts, blocks, steps, or the like in the flow diagram (500) may be performed in the order presented, in a different order or simultaneously. Further, in some embodiments, some of the actions, acts, blocks, steps, or the like may be omitted, added, modified, skipped, or the like without departing from the scope of the disclosure.

According to various example embodiments of the disclosure, a method for creating a toggled application icon (180) is provided. The method may include: identifying, by an electronic device (100), a plurality of applications (170a-170n) running on the electronic device (100), being actively toggled on a user interface (160) of the electronic device (100) based on a context, detecting, by the electronic device (100), at least one application of the plurality of applications (170a-170n) as at least one foreground application, wherein the at least one foreground application is accessible through a first application icon, detecting, by the electronic device (100), at least one application of the plurality of applications (170a-170n) as at least one background application, wherein the at least one background application is accessible through a second application icon, and generating, by the electronic device (100), the toggled application icon (180), wherein at least one of the at least one foreground application and the at least one background application is accessible through the toggled application icon based on the context.

The method may further include: causing to display the toggled application icon (180) on the user interface (160), and launching the at least one foreground application and the at least one background application simultaneously on the user interface (160) with a gesture on the toggled application icon (180).

A user interface of the foreground application overlaps at least a portion of a user interface of the background application.

A user interface of the foreground application does not overlap at least a portion of a user interface of the background application.

The method may further include: causing to display the toggled application icon (180) on the user interface (160), and launching at least one of the at least one foreground application and the at least one background application with a gesture on the toggled application icon (180).

The method may further include: causing to display the toggled application icon (180) on the user interface (160), and launching the at least one foreground application on another electronic device communicably coupled to the electronic device (100) and the at least one background application on the electronic device (100).

The method may further include: causing to display the toggled application icon (180) on another electronic device communicably coupled to the electronic device (100), and launching at least one of the at least one foreground application and the at least one background application with a gesture on the toggled application icon (180).

The context includes at least one of intent, time, type of the application being toggled, a recency of the task, a point of a launch of the application, frequency of toggling and location.

The type of the applications being toggled is determined based on a service category, a location of the electronic device (100) and an intent of the at least one task.

The frequency of toggling is determined based on a number of switching between the applications, total time spent on the applications and frequency weightage.

The time is determined based on an active screen time of the at least one application.

The method may further include: determining, by the electronic device (100), a preference of the user on the toggled application icon (180) learned using a machine learning procedure, and displaying the the toggled application icon (180) in at least one portion of the electronic device (100) based on the preference of the user.

According to various example embodiments of the disclosure, an electronic device (100) for creating an toggled application icon may include: a memory (130) storing a plurality of applications (170a-170n), a processor (120), and a toggle switcher (110), communicably coupled to the memory (130) and the processor (120), configured to: identify the plurality of applications (170a-170n) running on the electronic device (100), being actively toggled on a user interface (160) of the electronic device (100) based on a context, detect at least one application of the plurality of applications (170a-170n) as at least one foreground application, wherein the at least one foreground application is accessible through a first application icon, detect at least one application of the plurality of applications (170a-170n) as at least one background application, wherein the at least one background application is accessible through a second application icon, and generate the toggled application icon (180), wherein at least one of the at least one foreground application and the at least one background application is accessible through the toggled application icon (180) based on the context.

In the electronic device according to various example embodiments, the toggle switcher (110) is further configured to: cause to display the toggled application icon (180) on the user interface (160), and launch the at least one foreground application and the at least one background application simultaneously on the user interface with a gesture on the toggled application icon (180).

In the electronic device according to various example embodiments, a user interface of the foreground application overlaps at least a portion of a user interface of the background application.

In the electronic device according to various example embodiments, a user interface of the foreground application does not overlap at least a portion of a user interface of the background application.

In the electronic device according to various example embodiments, the toggle switcher (110) is further configured to: cause to display the toggled application icon (180) on the user interface (160), and launch at least one of the at least one foreground application and the at least one background application with a gesture on the toggled application icon (180).

In the electronic device according to various example embodiments, the toggle switcher (110) is further configured to: cause to display the toggled application icon (180) on the user interface (160), and launch the at least one foreground application on another electronic device communicably coupled to the electronic device (100) and the at least one background application on the electronic device (100).

In the electronic device according to various example embodiments, the toggle switcher (110) is further configured to: cause to display the toggled application icon (180) on another electronic device communicably coupled to the electronic device (100), and launch at least one of the at least one foreground application and the at least one background application with a gesture on the toggled application icon (180).

In the electronic device according to various example embodiments, the context includes at least one of intent, time, type of the applications being toggled, a point of a launch of the application, a recency of a task, frequency of toggling and location.

In the electronic device according to various example embodiments, the type of applications being toggled is determined based on a service category, a location of the electronic device (100) and an intent of the at least one task.

In the electronic device according to various example embodiments, the frequency of toggling is determined based on a number of switching between the applications, total time spent on the applications and frequency weightage.

In the electronic device according to various example embodiments, the time is determined based on an active screen time of the at least one application.

In the electronic device according to various example embodiments, the toggle switcher (110) is further configured to: determine a preference of the user on the toggled application icon (180) learned using a machine learning procedure, and display the the toggled application icon (180) in at least one portion of the electronic device (100) based on the preference of the user.

According to various embodiments of the disclosure, a method for creating a toggled application icon may include: switching, by an electronic device (100), between a first application from a plurality of applications (170a-170n) and a second application from the plurality of applications (170a-170n), determining, by the electronic device (100), user intent associated with the first application and the second application, and generating, by the electronic device (100), the toggled application icon based on the user intent, wherein the toggled application icon includes the first application and the second application based on the user intent.

The method may further include: recommending, by the electronic device (100), another toggled application icon based on the user intent, wherein the another toggled application icon comprises at least one of the combination of the first application and a third application similar to the second application and combination of a fourth application similar to the first application and the second application.

The method may further include: causing to display at least one of the toggled application icon and another toggled application icon on the user interface (160), and performing one of: launching the first application and the second application simultaneously on the user interface (160) with a gesture on the toggled application icon, launching the first application and the third application simultaneously on the user interface (160) with the gesture on another toggled application icon, and launching the fourth application and the second application simultaneously on the user interface (160) with the gesture on another toggled application icon.

The method may further include: causing to display at least one of the toggled application icon and another toggled application icon on the user interface (160), and performing one of: launching the first application and the second application on the user interface (160) with a gesture on the toggled application icon, launching the first application and the third application on the user interface (160) with the gesture on another toggled application icon, and launching the fourth application and the second application on the user interface (160) with the gesture on another toggled application icon.

The method may further include: causing to display at least one of the toggled application icon and another toggled application icon on the user interface (160), and performing one of: launching the first application on another electronic device communicably coupled to the electronic device (100) and the second application on the electronic device (100), launching the first application on another electronic device communicably coupled to the electronic device (100) and the third application on the electronic device (100), and launching the fourth application on another electronic device communicably coupled to the electronic device (100) and the second application on the electronic device (100).

The method may further include: causing to display the toggled application icon and another toggled application icon on another electronic device communicably coupled to the electronic device (100), and performing one of: launching the first application and the second application on the user interface (160) with a gesture on the toggled application icon, launching the first application and the third application on the user interface (160) with the gesture on another toggled application icon, and launching the fourth application and the second application on the user interface (160) with the gesture on another toggled application icon.

The toggled application icon is generated based on at least one foreground feature associated with the user intent and a background feature associated with the user intent.

The method may further include: determining a preference of the user on the toggled application icon learned using a machine learning procedure, and displaying the the toggled application icon in at least one portion of the electronic device based on the preference of the user.

According to various embodiments of the disclosure, an electronic device (100) for creating a toggled application icon may include: a memory (130) storing a plurality of applications (170a-170n), a processor (120), and a toggle switcher (110), communicably coupled to the memory (130) and the processor (120), configured to: switch between a first application from a plurality of applications (170a-170n) and a second application from the plurality of applications (170a-170n), determine user intent associated with the first application and the second application, and generate the toggled application icon based on the user intent, wherein the toggled application icon includes the first application and the second application based on the user intent.

In the electronic device according to various example embodiments, the toggle switcher (110) is configured to: recommended another toggled application icon based on the user intent, wherein the another toggled application icon comprises at least one of the combination of the first application and a third application substantially similar to the second application and combination of a fourth application substantially similar to the first application and the second application.

In the electronic device according to various example embodiments, the toggle switcher (110) is configured to: cause to display at least one of the toggled application icon and another toggled application icon on the user interface (160), and perform one of: launch the first application and the second application simultaneously on the user interface (160) with a gesture on the toggled application icon, launch the first application and the third application simultaneously on the user interface (160) with the gesture on another toggled application icon, and launch the fourth application and the second application simultaneously on the user interface (160) with the gesture on another toggled application icon.

In the electronic device according to various example embodiments, the toggle switcher (110) is configured to: cause to display at least one of the toggled application icon and another toggled application icon on the user interface (160), and perform one of: launch the first application and the second application on the user interface (160) with a gesture on the toggled application icon, launch the first application and the third application on the user interface (160) with the gesture on another toggled application icon, and launch the fourth application and the second application on the user interface (160) with the gesture on another toggled application icon.

In the electronic device according to various example embodiments, the toggle switcher (110) is configured to: cause to display at least one of the toggled application icon and another toggled application icon on the user interface (160), and perform one of: launch the first application on another electronic device communicably coupled to the electronic device (100) and the second application on the electronic device (100), launch the first application on another electronic device communicably coupled to the electronic device (100) and the third application on the electronic device (100), and launch the fourth application on another electronic device communicably coupled to the electronic device (100) and the second application on the electronic device (100).

In the electronic device according to various example embodiments, the toggle switcher (110) is configured to: cause to display the toggled application icon and another toggled application icon on another electronic device communicably coupled to the electronic device (100), and perform one of: launch the first application and the second application on the user interface (160) with a gesture on the toggled application icon, launch the first application and the third application on the user interface (160) with the gesture on another toggled application icon, and launch the fourth application and the second application on the user interface (160) with the gesture on another toggled application icon.

In the electronic device according to various example embodiments, the at least one processor is further configured to recommend one or more toggled application icons based on the intent of the user.

In the electronic device according to various example embodiments, the recommended one or more toggled application icons suggest one or more application combinations.

In the electronic device according to various example embodiments, the suggested one or more application combinations, upon execution, open corresponding one or more applications in at least one of a full screen view, a pop-up view, or another interface based on tasks that are executed.

In the electronic device according to various example embodiments, the toggled application icon is generated based on at least one foreground feature associated with the user intent and a background feature associated with the user intent.

In the electronic device according to various example embodiments, the toggle switcher (110) is further configured to: determine a preference of the user on the toggled application icon (180) learned using a machine learning procedure, and display the the toggled application icon (180) in at least one portion of the electronic device (100) based on the preference of the user.

The embodiments disclosed herein can be implemented using at least one software program running on at least one hardware device and performing network management functions to control the elements.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for creating an interactive application icon, the method comprising:
identifying, by an electronic device, a plurality of applications running on the electronic device, being actively toggled on a user interface of the electronic device based on a context;
detecting, by the electronic device, at least one application among the plurality of applications as at least one foreground application, the at least one foreground application being accessible through a first application icon;
detecting, by the electronic device, at least one application among the plurality of applications as at least one background application, the at least one background application being accessible through a second application icon; and
generating, by the electronic device, the interactive application icon,
wherein at least one of the at least one foreground application or the at least one background application is accessible through the interactive application icon based on the context.

2. The method of claim 1, further comprising:
displaying the interactive application icon on the user interface; and
launching the at least one foreground application and the at least one background application simultaneously on the user interface with a gesture on the interactive application icon.

3. The method of claim 2, wherein a user interface of the at least one foreground application overlaps at least a portion of a user interface of the at least one background application.

4. The method of claim 2, wherein a user interface of the at least one foreground application does not overlap at least a portion of a user interface of the at least one background application.

5. The method of claim 1, further comprising:
displaying the interactive application icon on the user interface; and
launching at least one of the at least one foreground application and the at least one background application with a gesture on the interactive application icon.

6. The method of claim 1, further comprising:
displaying the interactive application icon on the user interface; and
launching the at least one foreground application on another electronic device communicably coupled to the electronic device and the at least one background application on the electronic device.

7. The method of claim 1, further comprising:
displaying the interactive application icon on another electronic device communicably coupled to the electronic device; and
launching at least one of the at least one foreground application or the at least one background application with a gesture on the interactive application icon.

8. The method of claim 1, wherein the context includes at least one of an intent of a user, a time, a type of applications being toggled, a recency of at least one task, a point of a launch of an application among the plurality of applications, a frequency of toggling, or a location.

9. The method of claim 8, wherein the type of the applications being toggled is determined based on at least one of a service category, a location of the electronic device (100), or an intent of the at least one task.

10. The method of claim 8, wherein the frequency of toggling is determined based on a number of switching between the plurality of applications, total time spent on the plurality of applications and frequency weightage.

11. The method of claim 8, wherein the time is determined based on an active screen time of at least one application among the plurality of applications.

12. The method of claim 1, further comprising:
determining, by the electronic device, a preference of a user on the interactive application icon learned using a machine learning procedure; and
displaying the the interactive application icon in at least one portion of the electronic device based on the preference of the user.

13. An electronic device for creating an interactive application icon, the electronic device comprising:
a memory for storing a plurality of applications;
at least one processor; and
a toggle switcher communicably coupled to the memory and the at least one processor,
wherein the at least one processor is configured to control the toggle switcher to:
identify the plurality of applications running on the electronic device, being actively toggled on a user interface of the electronic device based on a context;
detect at least one application among the plurality of applications as at least one foreground application, the at least one foreground application being accessible through a first application icon;
detect at least one application among the plurality of applications as at least one background application, the at least one background application being accessible through a second application icon; and
generate the interactive application icon,
wherein at least one of the at least one foreground application or the at least one background application is accessible through the interactive application icon based on the context.

14. The electronic device of claim 13, wherein the at least one processor is further configured to control the toggle switcher to:
display the interactive application icon on the user interface; and
launch the at least one foreground application and the at least one background application simultaneously on the user interface with a gesture on the interactive application icon.

15. The electronic device of claim 14, wherein a user interface of the at least one foreground application overlaps at least a portion of a user interface of the at least one background application.

16. The electronic device of claim 14, wherein a user interface of the at least one foreground application does not overlap at least a portion of a user interface of the at least one background application.

17. The electronic device of claim 13, wherein the at least one processor is further configured to control the toggle switcher to:
display the interactive application icon on the user interface; and
launch at least one of the at least one foreground application or the at least one background application with a gesture on the interactive application icon.

18. The electronic device of claim 13, wherein the at least one processor is further configured to control the toggle switcher to:
display the interactive application icon on the user interface; and
launch the at least one foreground application on another electronic device communicably coupled to the electronic device and the at least one background application on the electronic device.

19. The electronic device of claim 13 wherein the at least one processor is further configured to control the toggle switcher to:
display the interactive application icon on another electronic device communicably coupled to the electronic device; and
launch at least one of the at least one foreground application or the at least one background application with a gesture on the interactive application icon.

20. The electronic device of claim 13, wherein the context includes at least one of an intent of a user, a time, a type of applications being toggled, a point of a launch of an application among the plurality of applications, a recency of at least one task, a frequency of toggling, or a location.
